(19) United States
(12) Patent Application Publication
(10) Pub. No.: US 2011/0253862 A1
(43) Pub. Date: Oct. 20, 2011

(54) Multi-purpose hook

(76) Inventors: Kenneth Barley, Frederick, MD (US); Charles E. Choux, Chesapeake Beach, MD (US)

(21) Appl. No.: 13/065,053

(22) Filed: Mar. 11, 2011

Related U.S. Application Data
(60) Provisional application No. 61/340,094, filed on Mar. 11, 2010.

(51) Int. Cl. F16B 45/00

(52) U.S. Cl. 248/225.21

(57) ABSTRACT

The present invention, hereinafter referred as the Multi-Purpose Hook provides a specially designed tool brace for use when working on scaffolds. The Multi-Purpose Hook is an oval, or circular metal ring, attached to the scaffold by means of a rear contact point where the vertical support of the scaffold joins to a horizontal cross brace of the scaffold. The device is comprised of metal rod, such as steel, or aluminum, which is essentially oval or circular having an opening for receiving the scaffold support. At the opening of the circle or oval the ends of the rod are bent perpendicular to the circle to form vertical sections and the vertical sections are again bent perpendicular to form horizontal sections, which terminate in hooks.

### CLAIM OF PRIORITY

This patent application claims priority under 35 USC 119(e)(1) from U.S. Provisional Patent Application Ser. No. 61/340,094 filed Mar. 11, 2011, of Kenneth Barley entitled, “Multi-Purpose Hook.”

### FIELD OF THE INVENTION

The present invention pertains to the field of utility storage devices, and more specifically to the field of utility tool storage hook devices.

### BACKGROUND OF THE INVENTION

The prior art has put forth several designs for utility tool storage devices. Among these are:

U.S. Pat. No. 6,302,238 to Mark A. Preusser and David L. Espenchied describes a support structure for moveably suspending a work surface from the underside of a bridge which includes at least a first clip mounted on each lower web of a pair of parallel bridge girders, a track mounted on each clip, and a scaffold member rollably suspended from the track, the work platform extending between the scaffold members. The scaffold members include a plurality of rollers that roll along the upper surface of each track such that the scaffold members are selectively rollable along the tracks. The clips are securely clamped to the lower webs of the girders such that the rails are securely and unadjustably spaced below the lower webs of the girders.

U.S. Pat. No. 6,659,521 to Thomas R. Hill, et al describes a system for hanging objects from conventional suspended ceilings which comprises resilient clips snap-fitted to ceiling rails, an installation tool for controlling the clips, and an elongated pole that threadably couples to the tool, enabling clip manipulation. Each clip comprises an upper clasp, an integral, lower hook, and a midportion. Clasp jaws that yieldably deflect apart comprise opposed flanges that forcibly grip the ceiling rails. The installation tool comprises receptacles for temporarily receiving the clips, and an internal, threaded bore mated to the installation pole. Each receptacle comprises a pair of generally planar retaining arms that partially block a captivation slot. The mid-portions of the clips slidably fit within the installation tool captivation slots. When pushed towards the ceiling rails the jaws snap apart and surmount the horizontal rail portion. When released, the jaws retract, with their flanges firmly gripping the rail.

U.S. Pat. No. 6,827,379 to Thomas R. Hill, et al describes an apparatus for deploying decorative wiring upon elevated locations. The apparatus, packaged in kit form, utilizes a pole for installing wiring from a stable ground position. An installation nut screws unto the pole for manipulating accessory tools that deploy the clips and wiring. The nut comprises captivating slots to which a clip controller and wire tool are alternately coupled. A prong projecting from the controller forcibly engages the wiring clips. After clip installation, wires are installed with the wire tool's arms. The controller and wire tool both comprise flexible legs fitted within the nut slots that are snap-fitted by detents. Each clip comprises a base plate, and an outwardly angled cradle for holding wiring. The gutter clip has a projecting latch terminating in a gutter-engaging barb. The adhesively-backed clip is press fitted to the target. A control region formed between the cradle and the base plate of each clip receives the controller prong.

None of these prior art references describe the present invention.

### SUMMARY OF THE INVENTION

It is an object of the present invention to provide an improved utility tool storage hook device.

### BRIEF DESCRIPTION OF THE DRAWINGS

FIG. 1 is a front perspective view and an elevational angled perspective view of the device of the present invention.

FIG. 2 is an elevational angled perspective view of the device of the present invention mounted on a scaffold.

### DETAILED DESCRIPTION OF THE INVENTION

A scaffold is an invaluable tool utilized by do-it-yourselfers as well as workers in a plethora of home improvement trades. For such professionals as construction workers, carpenters, contractors, electricians, and painters, these essential devices provide accessibility to ordinarily inaccessible locations. As such, it is often necessary to utilize a wide variety of tools when working on a scaffold. Whether nailing molding to a roofline, repairing the wiring in overhead lighting, or removing paint from a ceiling, multiple tools are usually needed for a particular task. However, while working on a scaffold, there is no safe place to secure tools in between applications. Should one place the tools down on the scaffold's top level, the risk of inadvertently knocking them off and onto the floor below rises dramatically, resulting in irreversible damage to these quite expensive instruments. In addition, a heavy tool falling from a high distance could cause injury to someone who may be standing nearby. While placing the tools on a more stable surface, such as a table or countertop, could conceivably prevent damage to the unit and harm to others, having to climb off the scaffold to retrieve a tool every time it is needed could turn a simple, satisfying home improvement project into one that is time consuming and frustrating.

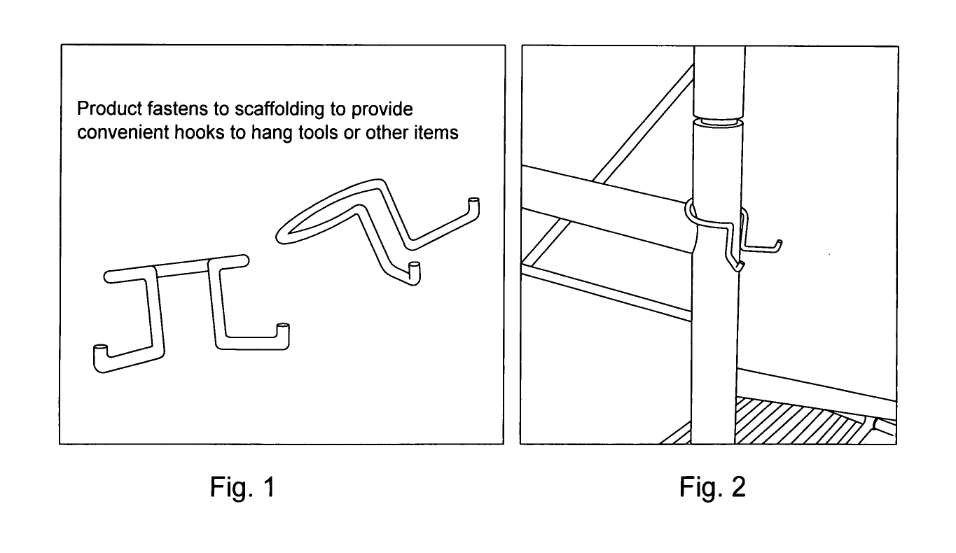

The present invention, hereinafter referred as the Multi-Purpose Hook offers a convenient solution to the challenges presented when using tools while on a scaffold. Simply stated, this product is a specially designed tool brace for use when working on scaffolds. The Multi-Purpose Hook is an oval, metal ring, attached to the scaffold by means of a rear contact point where the vertical support of the scaffold joins to a horizontal cross brace of the scaffold. The device is comprised of metal rod, such as steel, or aluminum, which is essentially oval or circular having an opening for receiving the scaffold support. At the opening of the circle or oval the ends of the rod are bent perpendicular to the circle to form vertical sections and the vertical sections are again bent perpendicular to form horizontal sections, which terminate in hooks. The configuration of the hook can be clearly seen in FIGS. 1 and 2. Universal in application, the Multi-Purpose Hook is used for storing handled tools, such as wrenches and putty knives, screwdrivers, levels and hammers as well as a plethora of items, such as measuring tapes, screws, nails, and chalk. With such a versatile product, the possibilities for storage and utilization are virtually limitless.

There are several significant benefits and advantages associated with this unique product invention. Foremost, the Multi-Purpose Hook provides consumers with an effective, hands-free means of managing and securing tools while working on a scaffold. A handy hook system, this practical product offers efficient storage for practically any tool needed. As a result, those working on scaffolds have a convenient, safe place to store tools while attending to the task at hand. Alleviating the risk that tools would fall onto the floor, the Multi-Purpose Hook prevents costly replacement of tools as well as injury to others. Keeping any desired tool handily within reach at all times, this functional accessory eliminates the need to keep instruments on safer surfaces, allowing users to complete tasks in an easy and expedient manner. While the Multi-Purpose Hook is ideal for the do-it-yourselfer, contractors, construction workers, electricians, painters, and even artists appreciate the benefits afforded by this time and money-saving device. The Multi-Purpose Hook is employed to alleviate the need to carry and entire tool box or bag around all day while working at a job site. Made of durable, high quality materials, this product withstands years of continued use.

An innovative product invention, the Multi-Purpose Hook readily enhances the repair experience. Compact and lightweight, this handy device proves an invaluable addition to any tool box or utility storage unit.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A utility tool storage hook device, comprising a tool brace for use when working on scaffolds, comprising an oval or circular metal ring, wherein the ring has an opening for receiving the scaffold support, and wherein at the opening of the circle or oval the ends of the rod are bent perpendicular to the circle to form vertical sections and the vertical sections are again bent perpendicular to form horizontal sections, which terminate in hooks.

2. The device of claim 1 comprised of aluminum rod.

3. The device of claim 3 comprised of steel rod.
